(19) United States
(12) Patent Application Publication
(10) Pub. No.: US 2005/0207324 A1
(43) Pub. Date: Sep. 22, 2005

(54) Magneto-optical recording medium and method of making the same and magneto-optical recording medium drive

(75) Inventors: Tetsuo Hosokawa, Kawasaki (JP); Tomoyuki Aita, Higashine (JP); Hidekazu Haga, Higashine (JP)

Correspondence Address: Patrick G. Burns, Esq.;GREER, BURNS & CRAIN, LTD., 300 South Wacker Dr., Suite 2500, Chicago, IL, 60606, US

(73) Assignee: FUJITSU LIMITED

(21) Appl. No.: 11/119,986

(22) Filed: May 2, 2005

Related U.S. Application Data
(63) Continuation of application No. PCT/JP03/06452, filed on May 23, 2003.

(51) Int. Cl. G11B 7/24

(52) U.S. Cl. 369/275.3

(57) ABSTRACT

A difference is set equal to or smaller than 47 nm between first and second birefringent values of a substrate. The first birefringent value is measured for a single pass of an optical beam passing through the substrate of an attitude rotated, relative to a reference plane perpendicular to the optical beam, by 20 degrees around the tangent line tangent to the sequence of phase pits at the projection of the optical beam on the substrate. The second birefringent value is measured for a single pass of the optical beam passing through the substrate of an attitude rotated, relative to the reference plane, by 20 degrees around a straight line extending within a plane including the surface of the substrate in a direction perpendicular to the sequence of phase pits. Jitter can be suppressed in the readout data from phase pits and magnetization in a magnetic film over the phase pits.

### BACKGROUND OF THE INVENTION

1. Field of the Invention

The present invention relates to a magneto-optical recording medium serving as both a ROM (Read Only Memory) made of phase pits formed on a substrate and a RAM (Random Access Memory) made of a magneto-optical recording layer, and to a magneto-optical recording medium drive therefor. In particular, the invention relates to a magneto-optical recording medium and a magneto-optical recording medium drive contributing to a superior readout of information from both the ROM and RAM.

2. Description of the Prior Art

FIG. 21 illustrates a plan view of a conventional magneto-optical disk according to the ISO standard. As shown in FIG. 21, the magneto-optical disk 70 includes a read-in area 71, a readout area 72, and a user area 73. The read-in and readout areas 71, 72 are the ROM area comprising phase pits. The phase pits correspond to depressions formed on the surface of a polycarbonate substrate. The depth of the phase pits are set to maximize the modulation of the optical intensity in the readout of the information. The user area 73 corresponds to the RAM area between the read-in and readout areas 71, 72. The user is allowed to record any information into the RAM area.

FIG. 22 illustrates an enlarged view of the user area 73. As shown in FIG. 22, phase pits 78 for header sections 76 and a user data sections 77 are established on lands 75 between grooves 74 serving as tracking guides. The user data sections 77 are made of the flat land 75 interposed between the grooves 74. Magneto-optical signals are recorded as information in the user data sections 77.

A laser beam of a smaller intensity is applied to the user area 73 in readout of magneto-optical signals. The plane of polarization is rotated in the laser beam in response to the magnetization in the recording layer based on the polar Kerr effect. The signals are determined based on the intensity of the polarization component of the reflected beam. The RAM information is thus read out.

The research has been developed to utilize the aforementioned characterized features of the magneto-optical disk. As disclosed in Japanese Patent Publication No. 6-202850, for example, a so-called concurrent ROM-RAM optical disk has been proposed for simultaneous reproduction of ROM and RAM information. FIG. 23 illustrates a sectional view of a magneto-optical recording medium 81 for simultaneous reproduction of ROM and RAM information along the radial direction. The magneto-optical recording medium 81 includes a substrate 83 made of polycarbonate or the like. Phase pits 82 are formed on the substrate 83 based on injection molding. A dielectric film 84, a magneto-optical recording film 85 such as TbFeCo or the like, a dielectric film 86, an aluminum reflection film 87 and an ultraviolet setting resin film 88 as a protection layer are sequentially formed on the surface of the substrate 83.

As shown in FIGS. 23 and 24, the ROM information is fixed in the magneto-optical recording medium 81 based on the sequence of phase pits PP formed on the substrate 83. The RAM information OMM is recorded over the sequence of the phase pits PP based on the magneto-optical recording in the magneto-optical recording film. FIG. 23 corresponds to the sectional view taken along the line 23-23 in FIG. 24. As shown in FIG. 24, the phase pits PP serve as tracking guides. No grooves 74 are formed. Many problems exist in simultaneous readout of the RAM information made of the phase pits PP and the RAM information based on the magneto-optical recording on the same side of the substrate.

The modulation of optical intensity required to accomplish the read out of the ROM information is one of the factors to generate noise in the reproduction signals of the RAM information. The present applicant proposed a solution in the International PCT application PCT/JP02/00159, filed Jan. 11, 2002. The feedback of an optical intensity modulation signal obtained from the readout of the ROM information is input to a laser diode for readout of information. This is believed to reduce noise in the modulation of optical intensity. However, noise cannot sufficiently be reduced if the modulation degree of optical intensity gets larger for the ROM information. In addition, it is difficult to feedback control the intensity of the laser at a higher speed.

The modulation degree of the optical intensity for the ROM information may be reduced to minimize noise from the phase pits, so that noise is intended to get reduced in the aforementioned RAM signals. However, the reproduction signals of a sufficient level can be obtained for the RAM information only if the intensity of the ROM signals gets extremely smaller. The readout of the ROM information is in this manner hindered. In other words, simultaneous readout of the ROM and RAM signals cannot be achieved even if the modulation degree of the optical intensity for the ROM information is adjusted.

### SUMMARY OF THE INVENTION

It is accordingly an object of the present invention to provide a magneto-optical recording medium and a magneto-optical recording medium drive contributing to a reliable achievement of simultaneous readout of the ROM information in the form of phase pits and the RAM information based on the magneto-optical recording. It is also an object of the present invention to provide a magneto-optical recording medium and a magneto-optical recording medium drive capable of suppressing jitter within a predetermined range in the reproduction signals of the ROM and RAM information.

According to the present invention, a difference, namely a birefringent difference is set equal to or smaller than 47 nm between first and second birefringent values, said first birefringent value being measured for a single pass of an optical beam passing through the substrate of an attitude rotated, relative to a reference plane perpendicular to the optical beam, by 20 degrees around a tangent line tangent to the sequence of phase pits at the projection of the optical beam on the substrate, said second birefringent value being measured for a single pass of the optical beam passing through the substrate of an attitude rotated, relative to the reference plane, by 20 degrees around a straight line extending within a plane including the surface of the substrate in a direction perpendicular to the sequence of phase pits.

When the birefringent difference is set equal to or smaller than 47 nm, jitter can sufficiently be suppressed in the readout of data from a magnetic recording film. In particular, the birefringent difference is preferably set equal to or smaller than 30 nm. The substrates may be made of polycarbonate or amorphous polyolefin, for example.

The optical depth of the phase pits may be set in a range between 0.06λ and 0.14λ, where λ is the wavelength of an optical beam for the readout of data. In general, the ROM information is recorded in the magneto-optical recording medium based on the phase pits. The deeper phase pits contribute to a reliable readout of the ROM information. The RAM information may be recorded in the magneto-optical recording medium based on the magnetization in the magnetic recording film. The shallower phase pits contribute to a reliable readout of the RAM information. The optical depth of the phase pits in a range as mentioned above contributes to a reliable readout of both the ROM and RAM information. In particular, the optical depth of the phase pits is preferably set in a range between 0.073λ and 0.105λ, where λ is the wavelength of an optical beam for the readout of data.

The phase pits may be set to have a modulation degree ranging from 8% to 55%, for example. The degree of modulation in the set range contributes to a reduced jitter equal to or less than 15% and a reliable tracking.

Injection molding is employed to form the mentioned recording medium made of polycarbonate or amorphous polyolefin. The substrate may be subjected to annealing treatment at the temperature equal to or higher than 90 degrees Celsius. The annealing treatment serves to suppress the birefringent difference of the substrates at a level equal to or smaller than 37 nm. In particular, the temperature equal to or higher than 100 degrees Celsius contributes to establishment of the birefringent difference equal to or smaller than 32 nm. In this case, jitter can be suppressed to a level equal to or less than 8% in the readout of the RAM information. It should be noted that the temperature should not exceed 130 degrees Celsius. If the temperature exceeds 130 degrees Celsius, the substrate may suffer from warp. The warp hinders a reliable readout of the RAM information. A magnetic recording film or layer is formed on the substrate after the annealing treatment.

A specific magneto-optical recording medium drive may be provided for realization of the aforementioned recording medium. The drive may include a light source emitting an optical beam; a spindle supporting a recording medium; and an optical system designed to direct the optical beam to the recording medium, said optical beam having the plane of polarization perpendicular to a recording track defining the sequence of phase pits. This drive enables a superior reduction in jitter as compared with the case where an optical beam is irradiated to have the plane of polarization in parallel with the recording track. The magneto-optical recording medium drive may further comprise: a first optical detector detecting a rotation of the plane of polarization between an optical beam reflected from the recording medium and an optical beam prior to reflection; and a second optical detector detecting the intensity of an optical beam reflected from the recording medium. The first optical detector is utilized for the readout of the RAM information. The second optical detector is utilized for the readout of the ROM information.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a perspective view of a magneto-optical disk;

FIG. 2 is an enlarged vertical sectional view taken along the line 2-2 in FIG. 1;

FIG. 3 is a schematic view for explaining a method of measuring the birefringence;

FIG. 4 is an enlarged partial perspective view of the magneto-optical disk for explaining the concept of track pitch, the width of a phase pit and the minimum length of the phase pit;

FIG. 5 is an enlarged partial vertical sectional view of a conventional continuous groove substrate employed in the land recording;

FIG. 6 is a schematic view for explaining a method of measuring the birefringence;

FIG. 7 is a graph illustrating the relationship between the birefringent difference and jitter in the readout of the RAM (Random Access Memory) information based on the magnetization of a magnetic recording film in the magneto-optical disk;

FIG. 8 is a graph showing the relationship between the birefringent difference and jitter in the readout of the ROM (Read Only Memory) information based on the phase pits;

FIG. 9 is a graph showing the relationship between the birefringent difference and jitter for reproduction of magneto-optical signals on substrates having a continuous land;

FIG. 10 is a graph showing the relationship between the birefringent difference for a perpendicular optical beam and the RAM jitter;

FIG. 11 is a table showing the relationship between the inclination angle of the substrate and the birefringent difference;

FIG. 12 is a graph showing the relationship between the inclination angle of the substrate and the birefringent difference when jitter is suppressed to a level equal to or less than 10%;

FIG. 13 is a table showing the birefringent difference, the RAM jitter and warp of the substrates for annealing treatment for various temperatures;

FIG. 14 is a graph showing the relationship between optical depth of phase pits and jitter in the readout of the RAM and ROM information;

FIG. 15 is a schematic view for explaining the degree of modulation;

FIG. 16 is a graph showing the relationship between the degree of modulation and jitter in the readout of the RAM and ROM information;

FIG. 17 is a schematic view illustrating the structure of a magneto-optical disk drive;

FIG. 18 is an enlarged partial perspective view illustrating the relationship between a recording track and the plane of polarization for a laser beam;

FIG. 19 is a graph showing the relationship between the birefringent difference and jitter when a perpendicular or horizontal polarization is employed to read RAM information based on the magnetization in the magnetic recording film;

FIG. 20 is a graph showing the relationship between the birefringent difference and jitter when a perpendicular or horizontal polarization is employed to read ROM information based on the phase pits;

FIG. 21 is a plan view of a conventional magneto-optical disk according to the ISO standard;

FIG. 22 is an enlarged partial view of a user area on the conventional magneto-optical disk;

FIG. 23 is a partial vertical sectional view of the conventional magneto-optical disk at the user area; and

FIG. 24 illustrates the relationship between phase pits and magneto-optical signals on a magneto-optical disk for simultaneous readout of the ROM and RAM information.

### DESCRIPTION OF THE PREFERRED EMBODIMENT

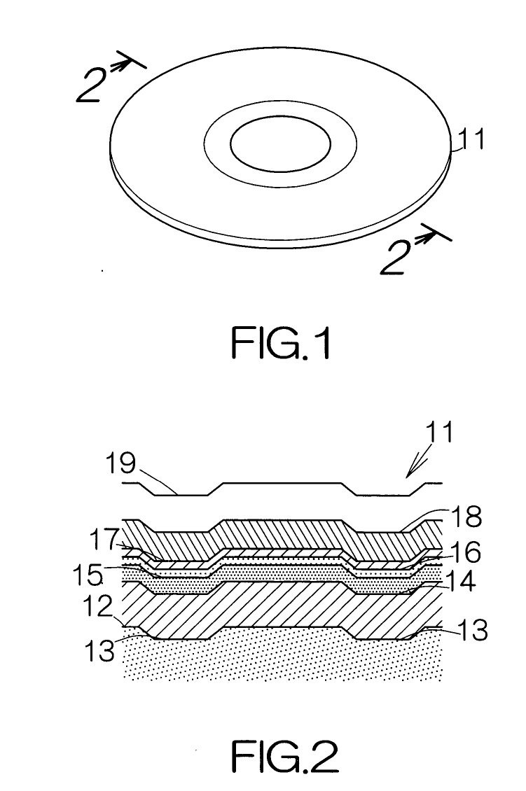

FIG. 1 illustrates a magneto-optical disk 11 as an example of a magneto-optical recording medium. The magneto-optical disk 11 takes the form of a concurrent ROM-RAM magneto-optical disk. The diameter of the magneto-optical disk 11 is set at 120 mm, for example.

FIG. 2 schematically illustrates a sectional view of the magneto-optical disk 11. The magneto-optical disk 11 includes a substrate 12. The substrate 12 is made of a transparent material. The material may be a resin material such as polycarbonate, amorphous polyolefin, or the like. Injection molding is employed to form the substrate 12.

Phase pits 13 are formed on the surface of the substrate 12 based on a transfer from the molding die. The phase pits 13 correspond to depressions formed on the surface of the substrate 12. The substrate of the type is hereinafter referred to as “phase pit substrate”. An undercoat film 14, a magnetic recording film 15, an auxiliary magnetic film 16, an overcoat film 17, a reflection film 18 and a protection film 19 are sequentially formed on the surface of the substrate 12. The undercoat film 14, the magnetic recording film 15, the auxiliary magnetic film 16, the overcoat film 17, the reflection film 18 and the protection film 19 are all overlaid on the phase pits 13. User data is held in the magnetic recording film 15 over the phase pits 13 in the magneto-optical disk 11.

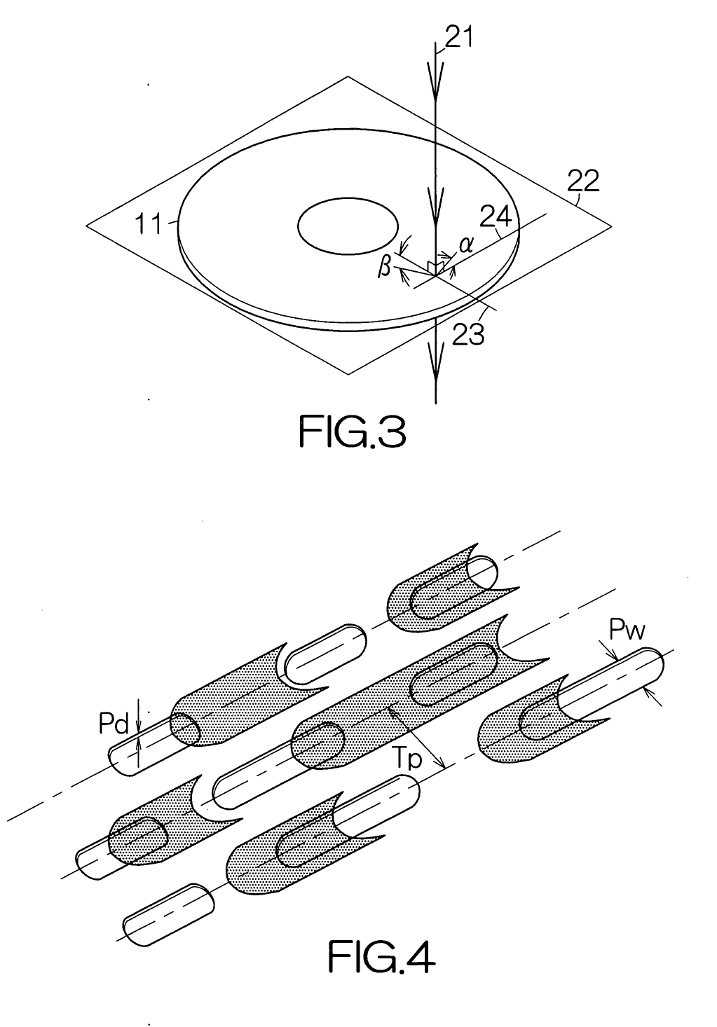

A difference is set equal to or smaller than 47 nm between first and second birefringent values. This difference is hereinafter referred to as “birefringent difference”. In this case, the first birefringent value is obtained based on measurement on the substrate 12 for a single pass of a first inclined incident optical beam. The second birefringent value is likewise obtained based on measurement on the substrate 12 for a single pass of a second inclined incident optical beam. As shown in FIG. 3, for example, the substrate 12 is kept in an attitude rotated by an inclination angle α of 20 degrees, relative to a reference plane 22 perpendicular to an optical beam 21 for measurement, around a radial line 23 passing through the projection of the optical beam 21 on the substrate 12 for the measurement of the first birefringent value. Likewise, the substrate 12 is kept in an attitude rotated by an inclination angle β of 20 degrees, relative to the reference plane 22, around a tangent line 24 tangent to the sequence of the phase pits or tracking line at the projection of the optical beam 21 on the substrate 12 for the measurement of the second birefringent value. A conventional birefringent measurement instrument may be employed to measure the first and second birefringent values.

The inventors prepared phase pit substrates having the thickness of 1.2 mm. The phase pit substrate includes, as shown in FIG. 4, phase pits of the eight to fourteen modulation (EFM). The track pitch Tp was set at 1.6 μm between the adjacent sequences of phase pits. The width Pw of the phase pits was set at 0.40 μm. The minimum length of the phase pit was set at 0.832 μm. Injection molding was employed to form the phase pit substrates. Here, stampers were prepared to have phase pits of different depths. The phase pit substrates were thus formed to have the phase pits of different depths. As shown in FIG. 5, the inventors also prepared a conventional substrate having a continuous groove for a continuous land recording. The substrates of the type is hereinafter referred to as “continuous groove substrate”. The track pitch was set at 0.90 μm between the adjacent turns of the groove. The same material was employed to form the phase pit and continuous groove substrates. The conditions of annealing treatment were also set common to the phase pit and continuous groove substrates. The formed substrates were set in the birefringent measurement instrument. As shown in FIG. 6, the birefringent values were measured in the aforementioned manner. ADR-200B distributed from Orc Manufacturing Co., Ltd. was employed as the birefringent measurement instrument. The wavelength of the laser beam was set at 635 nm in the measurement.

Next, magneto-optical disks were formed based on the aforementioned phase pit and continuous groove substrates. Various conditions were set for annealing treatment effected on the phase pit and continuous groove substrates. The phase pit and continuous groove substrates were then set in a sputtering apparatus. A vacuum equal to or smaller than 5xe⁻⁵ [Pa] was set in the chambers of the sputtering apparatus. A Si target is set in a first chamber. The phase pit and continuous groove substrates were transported into the first chamber. Ar gas and N₂ gas were introduced into the first chamber. Reactive sputtering was effected in the first chamber. The undercoat film 14 made of a SiN film having the thickness of 80 nm was formed on the substrates.

Next, the phase pit and continuous groove substrates were transported into a second chamber of the sputtering apparatus. The magnetic recording film 15 made of a Tb₂₂(FeCo₁₂)₇₈ film having the thickness of 30 nm and the auxiliary magnetic film 16 made of a Gd₁₉(FeCo₂₀) film having the thickness of 4 nm were sequentially formed in the second chamber. The phase pit and continuous groove substrates were then transported into the first chamber. The overcoat film 17 made of a SiN film having the thickness of 5 nm and the reflection film 18 made of an aluminum film having the thickness of 50 nm were formed in the first chamber. The protection film 19 made of an ultraviolet setting resin coating was subsequently formed on the reflection film 18. The magneto-optical disks were prepared in this manner.

The magneto-optical disks were sequentially set in a recording/reproducing apparatus. ROM jitter was measured based on the sequence of phase pits in the recording/reproducing apparatus. RAM jitter was also measured based on the reproduction of the magneto-optical recording over the sequence of the phase pits in the recording/reproducing apparatus. The wavelength of the laser beam was set at 650 nm in the recording/reproducing apparatus. The numerical aperture NA was set at 0.55. The linear velocity was set at 4.8 [m/s]. Magnetic field modulation recording was employed to establish a predetermined data of the eight to fourteen modulation in the magnetic recording films on the magneto-optical disks. The shortest length of the mark was set at 0.832 μm. The reproduction power of the laser was set at 1.5 [mW] in the measurement of jitter for both the ROM and RAM information. The DC radiation having the laser power Pw of 8.0 [mW] was employed in the magnetic field modulation recording. The plane of polarization was set in the direction perpendicular to the tracking line in the laser beam in the reproduction process. It should be noted that the same effect can be achieved in the optical modulation recording in place of the magnetic field modulation recording.

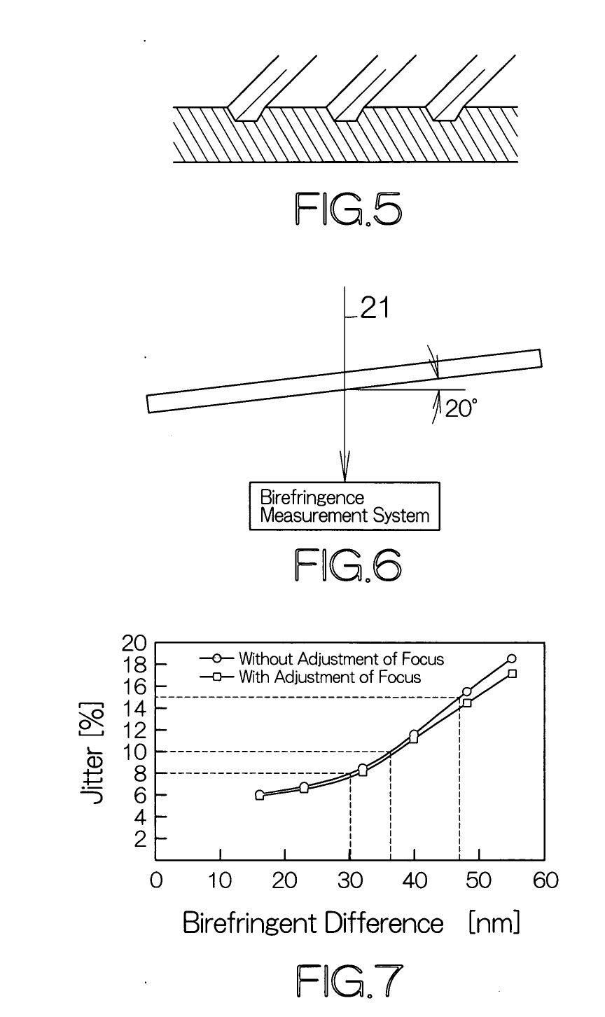

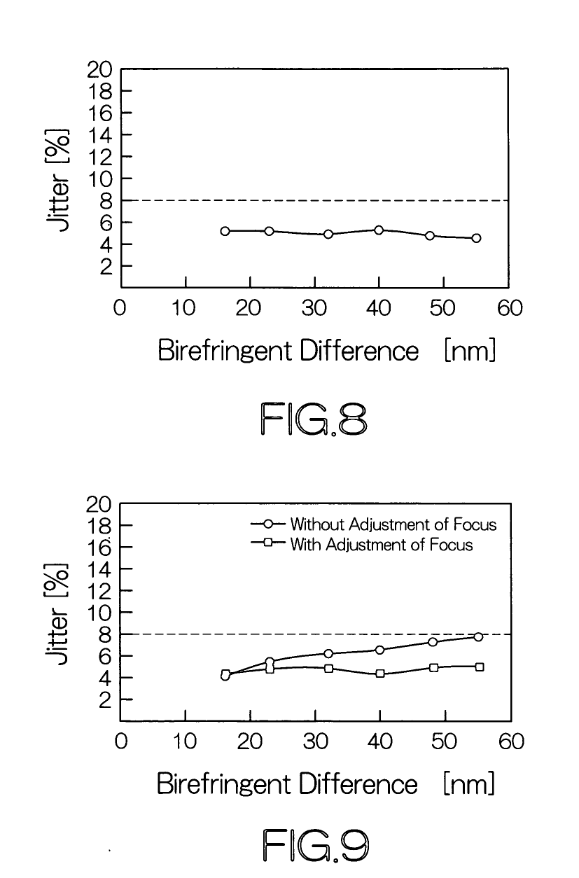

FIGS. 7 and 8 illustrate the result of the measurement. The optical depth of the phase pits was set at 0.095λ, equal to the substantial depth of 40 nm. FIG. 7 illustrates jitter in the magneto-optical reproduction and RAM. FIG. 8 illustrates the ROM jitter for the phase pits. Panlite® ST-3000 and AD-900TG, distributed from Teijin Chemicals Limited, were employed as the material for the phase pit substrates. Injection molding was employed to form the phase pit substrates. Annealing treatment was effected on the phase pit substrates at the temperature of 90, 110 or 130 degrees Celsius. Six magneto-optical disks were in this manner prepared to have different birefringent differences for the first and second inclined incident optical beams. Six magneto-optical disks were likewise prepared to have different birefringent differences for the continuous groove substrates. The same material and conditions were set for the continuous groove substrates. FIG. 9 illustrates the result for the magneto-optical disks employing the continuous groove substrates. The undercoat film made of SiN, the magnetic recording film made of TbFeCo, the auxiliary magnetic film, the overcoat made of SiN, the aluminum reflection film and the protection film were similarly formed on the continuous groove substrates. A predetermined data was written into the magnetic recording film on the continuous groove substrates based on the tracking servo control employing the land.

As shown in FIG. 7, it has been confirmed that an increased birefringent difference induces a considerable increase in the RAM jitter for the magneto-optical recording on the phase pits. In general, the CICR, Cross-Interleaved read-Solomon Code, is utilized in error correction for compact disks (CDs). Error rate equal to or smaller than 1×10⁻² ensures a sufficient quality for substantial error correction. The error rate of the mentioned level can be achieved if a jitter is set equal to or less than 15%. The birefringent difference may thus be set equal to or smaller than 47 nm between the first and second inclined incident optical beams. If uncertain factors to increase jitter are taken into account, a jitter equal to or less than 10% should be established. Specifically, the birefringent difference should be set equal to or smaller than 37 nm for the first and second inclined incident optical beams. If the maximum uncertain factors are taken into account, the jitter should be set equal to or less than 8%. Specifically, the birefringent difference should be set equal to or smaller than 30 nm for the first and second inclined incident optical beams. No error can be found in the readout of data under the various uncertain factors, so that a sufficient quality can be achieved, if a jitter is set equal to or less than 8%. Here, the inventors tried to suppress the RAM jitter based on adjustment of focus for the objective lens. However, the RAM jitter was only slightly improved. As shown in FIG. 8, the magneto-optical disks employing the phase pit substrate were allowed to enjoy a constant ROM jitter for the various birefringent differences between the first and second inclined incident optical beams. In other words, a smaller birefringent difference between the first and second birefringent values enables reduction in the RAM jitter.

FIG. 9 illustrates the result of the land recording as a conventional recording method. The jitter gradually increases in the land recording as the birefringent difference gets larger. The jitter can be reduced to a level equal to or less than 8% even if the birefringent difference reaches 50 nm. The inventors likewise tried to reduce the jitter based on adjustment of the focus, an increase in the RAM jitter was completely suppressed irrespective of variation in the birefringent difference.

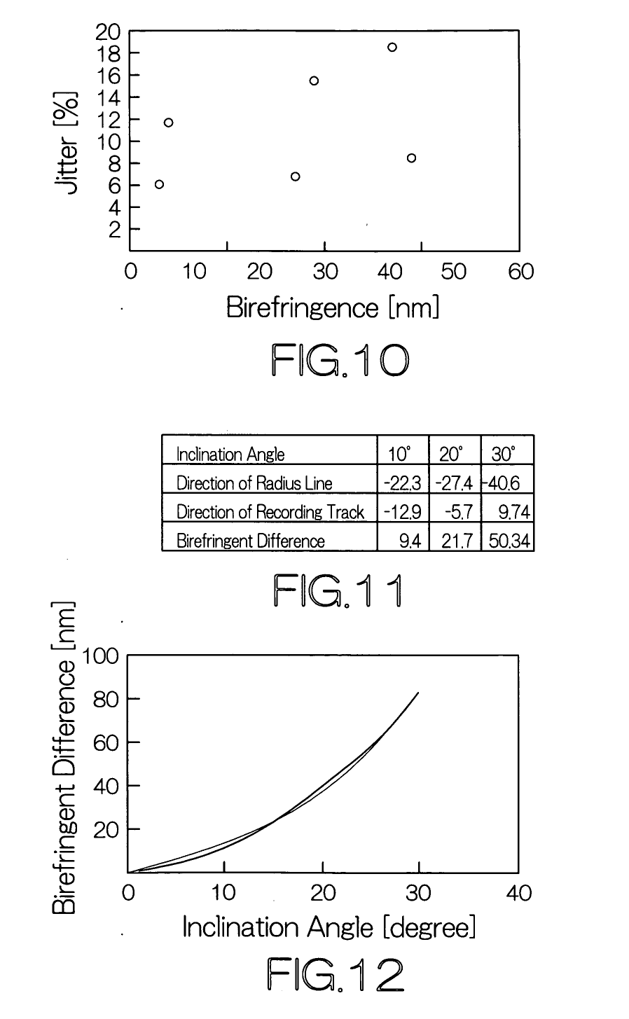

FIG. 10 illustrates the relationship between the jitter and the birefringence for the perpendicular incidence of the optical beam on the phase pit substrate. Here, the inclination angles α, β were set at zero degrees in the measurement of the birefringence for the perpendicular incidence. In other words, the substrates were kept in an attitude perpendicular to the laser beam 24. This is a conventional method of measuring birefringence. As shown in FIG. 10, there is no correlation between the birefringence for the perpendicular incidence and the RAM jitter. As shown in FIG. 3, the RAM jitter on the phase pits has a close relationship with the direction of inclination in the measurement of the birefringence.

FIG. 11 illustrates the relationship between the inclination angles α, β and the birefringent difference. An increased inclination angle induces an increase in the birefringent difference between the radial direction and the direction of the sequence of the phase pits. FIG. 12 illustrates the relationship between the inclination of the substrate and the birefringent difference when the jitter is suppressed to a level equal to or less than 10%. The following relationship should be satisfied where y denotes the birefringent difference and X denotes the inclination angle of the substrate:

[Equation 1]
y=0.082X²+0.324X (1)

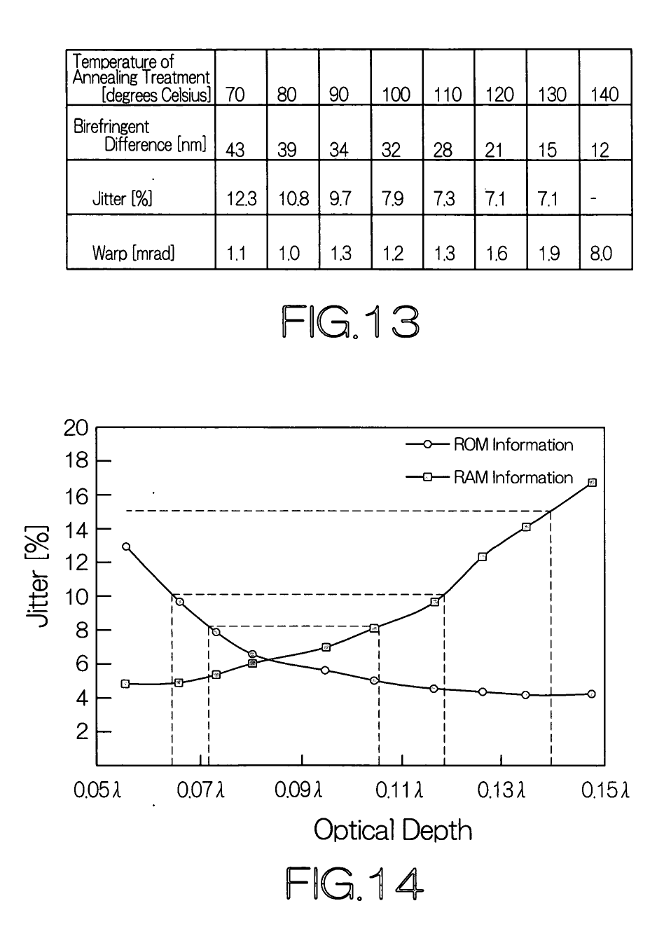

Next, the inventors prepared the phase pit substrates in the aforementioned manner. Here, the optical depth of the phase pits were set at 0.095λ, equal to the substantial depth of 40 nm. Panlite® ST-3000 polycarbonate was employed as the material for the phase pit substrates. Injection molding was employed to form the phase pit substrates. As shown in FIG. 13, the annealing treatment of various temperatures was effected. The annealing treatment was maintained for the duration of 30 minutes. As is apparent from FIG. 13, when the temperature for the annealing treatment was set equal to or higher than 90 degrees Celsius, the birefringent difference can be set equal to or smaller than 37 nnm. The jitter can be suppressed to a level equal to or less than 10%. When the temperature for the annealing treatment was set equal to or higher than 100 degrees Celsius, the jitter can be suppressed to a level equal to or less than 8%. Measurement cannot be effected on the substrate due to a warp if the temperature for the annealing treatment is set equal to or higher than 140 degrees Celsius. The temperature for the annealing treatment may preferably be set in a range between 90 degrees Celsius and 130 degrees Celsius.

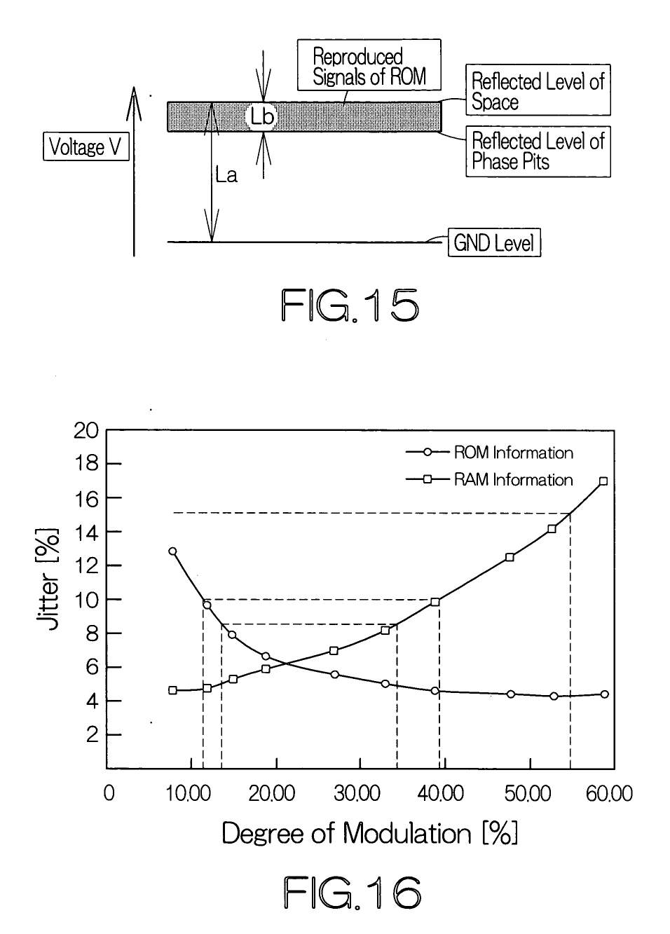

Next, the inventors prepared the phase pit substrates in the aforementioned manner. Panlite® ST-3000 polycarbonate was employed as the material of the phase pit substrates. The temperature was set at 130 degrees Celsius for the annealing treatment. As shown in FIG. 14, the optical depth of the phase pits were varied. As is apparent from FIG. 14, if the optical depth of the phase pit was set equal to or smaller than 0.14λ, the RAM jitter was suppressed to a level equal to or less than 15%. It should be noted that a stable tracking cannot be achieved if the optical depth for the phase pits was below 0.06λ. A normal recording/reproducing cannot be realized. The optical depth of the phase pits should be set equal to or larger than 0.06λ. If the optical depth is set in a range between 0.06λ and 0.14λ, a stable tracking and the jitter equal to or less than 15% can be achieved. In addition, if the optical depth is set in a range between 0.065λ and 0.118λ, the ROM jitter and the RAM jitter are both set equal to or less than 10%. If the optical depth is set in a range between 0.073λ and 0.105λ, the ROM jitter and the RAM jitter are both set equal to or less than 8%. Here, the depth of the phase pits can be adjusted based on the condition in making the stamper and the deep ultraviolet radiation effected on the substrate.

Next, the inventors prepared the phase pit substrates in the aforementioned manner. Panlite® ST-3000 polycarbonate was employed as the material for the phase pit substrates. Injection molding was employed to form the phase pit substrates. Various optical depths were set for the phase pits on the phase pit substrates. The annealing treatment was effected on the individual phase pit substrates at the temperature of 130 degrees Celsius for the duration of 30 minutes. Magneto-optical disks were prepared based on the phase pit substrates in the aforementioned manner. The degree of modulation and the jitter were measured for the prepared magneto-optical disks. The magneto-optical disks were sequentially set in a tester. The ROM information was reproduced from the phase pits based on the tracking servo of the phase pits. The wavelength of the laser beam was set at 650 nm. The numerical aperture NA was set at 0.55. The linear velocity was set at 4.8 [m/s]. Magnetic field modulation recording was employed to establish a predetermined data of the eight to fourteen modulation in the magnetic recording films on the magneto-optical disks. The shortest length of the mark was set at 0.832 μm. The ROM information was likewise established based on the phase pits having the shortest length of the mark equal to 0.832 μm of the eight to fourteen modulation. ROM jitter was measured based on the sequence of phase pits. RAM jitter was also measured based on the reproduction of the magneto-optical recording over the sequence of the phase pits. The reproduction power of the laser was set at 1.5 [mW] in the measurement of jitter for both the ROM and RAM information. The DC radiation having the laser power Pw of 8.0 [mW] was employed in the magnetic field modulation recording. The plane of polarization was set in the direction perpendicular to the tracking line in the laser beam in the reproduction process.

The intensity of the laser beam reflected from the magneto-optical disk was measured to calculate the degree of modulation. The optical intensity of the laser beam is detected at the divided photodetector for the perpendicular planes of polarization as described later in detail. Electric signals output from the photodetector are added at an addition amplifier. The intensity is in this manner detected for the overall laser beam. The electric signal after the addition is input into an oscilloscope. As shown in FIG. 15, the laser beam passing through the phase pits suffers from reduction in the reflected level. On the other hand, the laser beam irradiated at the space between the phase pits is allowed to enjoy an enhanced reflected level. The difference between the reflected levels corresponds to the intensity of the ROM signals based on the phase pits. Here, the degree of modulation is defined by a ratio between the reflected level La at the space and the intensity of the ROM signals Lb. Specifically, the degree M of modulation is expressed as follows:

$$\begin{matrix}[ Equation 2 ] & \\ M = 100 \cdot \frac{Lb}{La} & ( 2 )\end{matrix}$$

As is apparent from FIG. 16, when the degree of modulation gets higher, the ROM jitter is reduced while the RAM jitter increases. If the degree of modulation is set equal to or less than 55%, the ROM jitter and the RAM jitter are both suppressed to levels equal to or less than 15%. If the optical depth of the phase pits are reduced to lower the degree of modulation below 8%, a stable tracking cannot be achieved. A normal recording/reproducing cannot be realized. If the degree of modulation is set in a range between 8% and 55%, the jitter equal to or less than 15% can be achieved along with a stable tracking. If the degree of modulation is set in a range between 11% and 39%, the ROM jitter and the RAM jitter are both suppressed to levels equal to or less 10%. If the degree of modulation is set in a range between 14% and 34%, both the ROM jitter and the RAM jitter can be suppressed to levels equal to or less than 8%.

As described above, if the optical depth and the degree of modulation are adjusted in a condition where the birefringent difference is set as mentioned above between the first and second inclined incident optical beams, the jitter can sufficiently be suppressed for the ROM and RAM for substantial purposes. If the birefringent difference deviates from the aforementioned range, the jitter cannot be reduced enough even if the optical depth and the degree of modulation are adjusted.

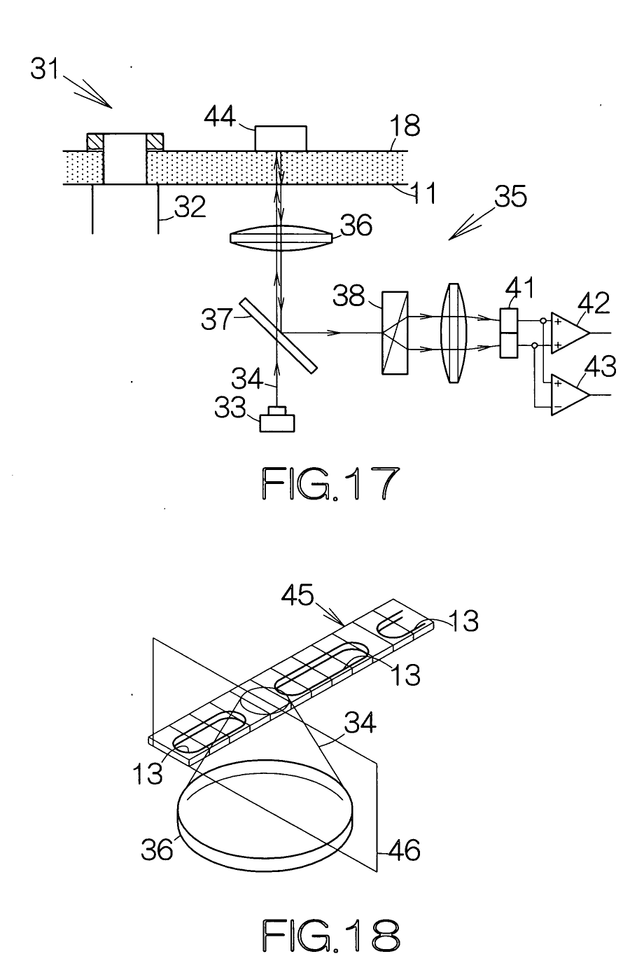

A magneto-optical disk drive 31 is employed to effect recording/reproducing operations on the magneto-optical disk 11. The magneto-optical disk 31 includes a spindle 32 designed to support the magneto-optical disk 11, as shown in FIG. 17. The spindle 32 serves to drive the magneto-optical disk 11 around the longitudinal axis of the spindle 32.

The magneto-optical disk drives 31 includes a light source or semiconductor laser diode 33. The semiconductor laser diode 33 is designed to emit an optical beam or laser beam 34 of a linear polarization. When the magneto-optical disk 11 is mounted on the spindle 32, a so-called optical system 35 serves to direct the laser beam 34 to the magneto-optical disk 11.

The optical system 35 includes an objective lens 36 opposed to the surface of the magneto-optical disk 11, for example. A beam splitter 37 is located between the semiconductor laser diode 33 and the objective lens 36, for example. The laser beam 34 from the semiconductor laser diode 33 passes through the beam splitter 37. The laser beam 34 passing through the beam splitter 37 is irradiated to the magneto-optical disk 11 through the objective lens 36. The objective lens 36 serves to form a minute beam spot on the surface of the magneto-optical disk 11. The laser beam 34 passes through the substrate 12, the undercoat film 14, the magnetic recording film 15, the auxiliary magnetic film 16 and the overcoat film 17 so as to reach the reflection film 18. The reflection film 18 reflects the laser beam 34. The reflected laser beam 34 is directed to the beam splitter 37 through the objective lens 36.

A two-beam Wollaston 38 is opposed to the beam splitter 37. The beam splitter 37 serves to reflect the returned laser beam 34 from the magneto-optical disk 11. The laser beam 34 is directed to the two-beam Wollaston 38 through the beam splitter 37. The two-beam Wollaston 38 resolves the laser beam 34 into components corresponding to planes of polarization perpendicular to each other.

A divided photodetector 41 is placed behind the two-beam Wollaston 38. The laser beams 34 is then detected for the respective planes of polarization at the divided photodetector 41 after the resolution at the two-beam Wollaston 38. The laser beam 34 is converted into electric signals for the respective planes of polarization. The electric signals for the planes of polarization are then summed at an addition amplifier 42. The intensity is detected for the overall laser beam 34. The ROM information is in this manner read out based on the output from the addition amplifier 42. The electric signals are subjected to subtraction at a subtraction amplifier 43. The rotation is detected between the plane of polarization of the laser beam 34 reflected from the magneto-optical disk 11 and the plane of polarization of the laser beam 34 before the reflection. The RAM information is in this manner read out based on the output from the subtraction amplifier 43.

A magnetic head slider 44 is opposed to the objective lens 36. An electromagnetic transducer is mounted on the magnetic head slider 44. The electromagnetic transducer may be located on the extension of the path of the laser beam 34 directed from the objective lends 36 to the magneto-optical disk 11. When the laser beam 34 is irradiated, the temperature of the magnetic recording film 15 rises. The electromagnetic transducer serves to apply a magnetic field for recordation to the magnetic recording film 15. The rise in the temperature allows the magnetization to rotate in the magnetic recording film 15 in response to the direction of the magnetic field for recordation. The RAM information is in this manner written into the magnetic recording film 15. It should be noted that the optical modulation recording may be employed in place of the aforementioned magnetic field modulation recording.

As shown in FIG. 18, the laser beam 34 of the magneto-optical disk drive 31 is irradiated along the plane 46 of polarization perpendicular to a tracking line 45 defining the sequence of phase pits. In other words, the perpendicular polarization is established in the laser beam 34 irradiated at the phase pits 13 as well as the magnetic recording film 15. The laser beam 34 of the perpendicular polarization contributes to reduction in the jitter in the readout of the ROM and RAM information.

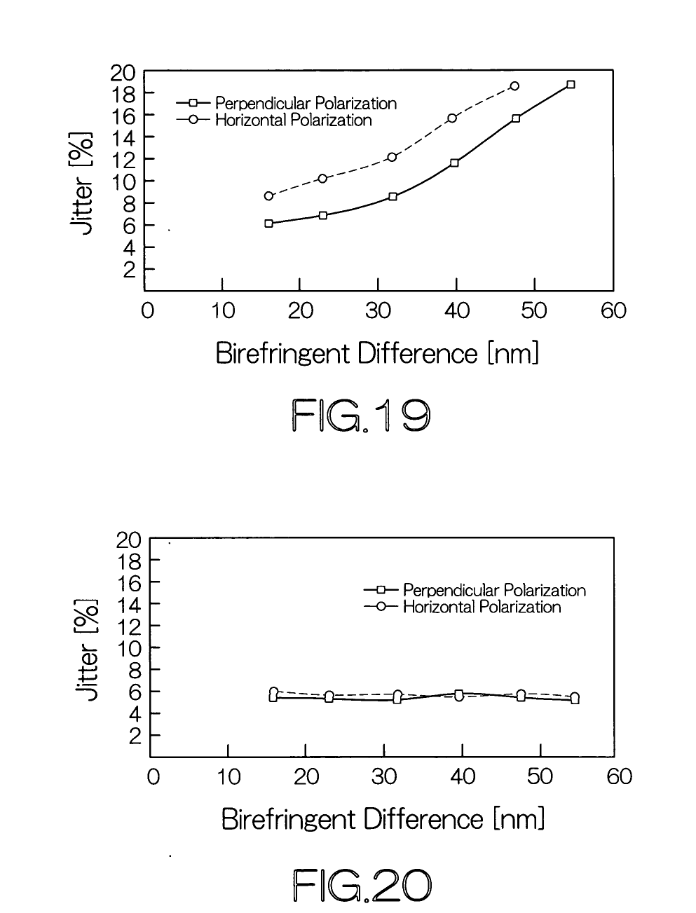

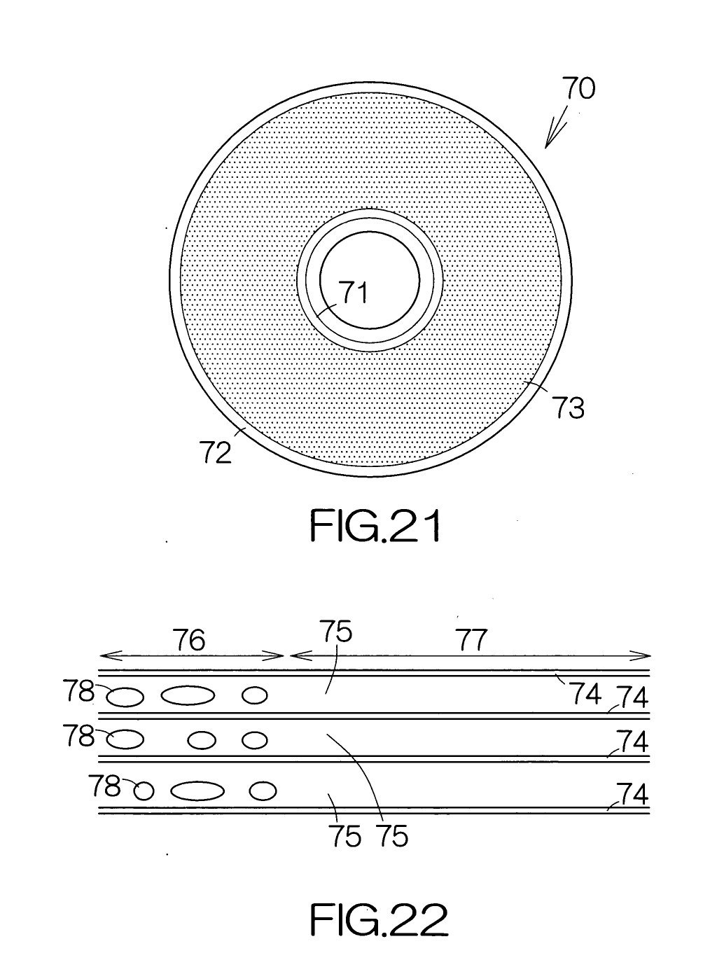

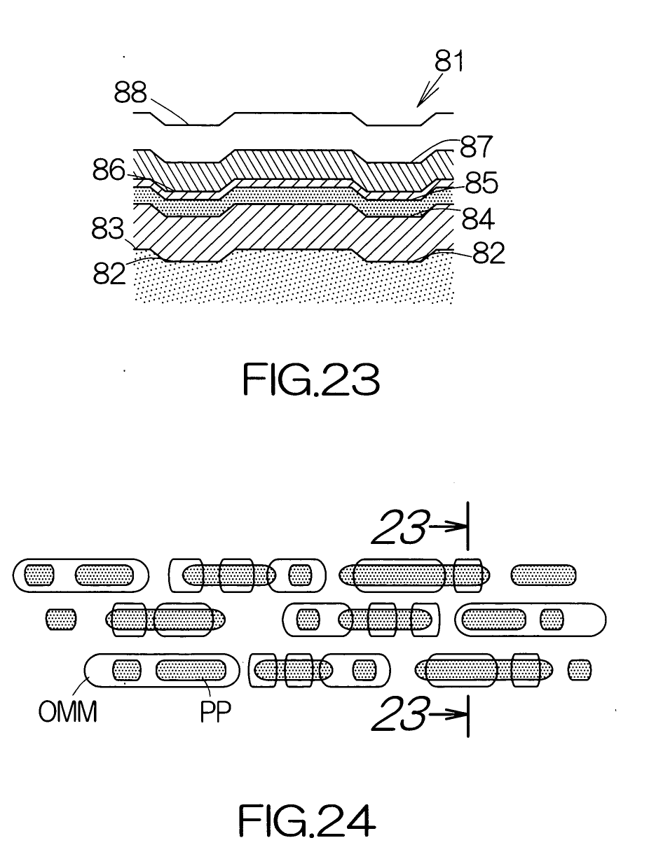

The inventors prepared six magneto-optical disks 11 in the aforementioned manner. The inventors measured the jitter for the respective examples. First and second laser beams were prepared. The perpendicular polarization was established in the first laser beam irradiated on the magneto-optical disk 11 in the same manner as the aforementioned magneto-optical disk drive 31. The plane of polarization was set in parallel with the recording track on the magneto-optical disk 11 in the second laser beam. Specifically, a so-called horizontal polarization was established in the second laser beam irradiated on the phase pits 13 and the magnetic recording film 15. As shown in FIG. 19, it is confirmed that the jitter can be reduced based on the employment of the perpendicular polarization rather than the horizontal polarization irrespective of the birefringent difference of the substrates 12 in the readout of the RAM information. As shown in FIG. 20, little difference is observed between the perpendicular polarization and the horizontal polarization in the readout of the ROM information.

1. A magneto-optical recording medium comprising:
a substrate having a ROM region including a sequence of phase pits; and
a magneto-optical recording film overlaid on the ROM region of the substrate for holding a RAM signal, wherein
a difference is set equal to or smaller than 47 nm between first and second birefringent values at least over a user area of the ROM region, said first birefringent value being measured for a single pass of an optical beam passing through the substrate of an attitude rotated by 20 degrees around a tangent line tangent to the sequence of phase pits at a projection of the optical beam on the substrate relative to a reference plane perpendicular to the optical beam, said second birefringent value being measured for a single pass of the optical beam passing through the substrate of an attitude rotated by 20 degrees around a straight line extending within a plane including a surface of the substrate in a direction perpendicular to the sequence of phase pits relative to the reference plane.

2. The magneto-optical recording medium according to claim 1, wherein said difference is set equal to or smaller than 30 nm.

3. The magneto-optical recording medium according to claim 1, wherein said phase pits have an optical depth ranging from 0.06λ to 0.14λ where λ is a wavelength of an optical beam for readout of data.

4. The magneto-optical recording medium according to claim 2, wherein said optical depth is set in a range between 0.073λ and 0.105λ.

5. The magneto-optical recording medium according to claim 1, wherein said phase pits are set to have a modulation degree ranging from 8% to 55%.

6. The magneto-optical recording medium according to claim 5, wherein said modulation degree is set in a range between 14% and 34%.

7. The magneto-optical recording medium according to claim 1, wherein said substrate is made of polycarbonate or amorphous polyolefin.

8. A method of making a magneto-optical medium, comprising:
forming a substrate based on injection molding; and
subjecting the substrate to annealing treatment at temperature equal to or higher than 90 degrees Celsius.

9. The method according to claim 8, wherein said temperature is set equal to or higher than 100 degrees Celsius.

10. The method according to claim 9, wherein a magnetic layer is formed on the substrate after the annealing treatment.

11. The method according to claim 9, wherein said temperature is set equal to or lower than 130 degrees Celsius.

12. The method according to claim 11, wherein a magnetic layer is formed on the substrate after the annealing treatment.

13. A magneto-optical recording medium drive comprising:
a light source emitting an optical beam;
a spindle supporting a recording medium; and
an optical system designed to direct the optical beam to the recording medium, said optical beam having a plane of polarization perpendicular to a recording track defining a sequence of phase pits.

14. The magneto-optical recording medium drive according to claim 13, further comprising:
a first optical detector detecting a rotation of the plane of polarization between an optical beam reflected from the recording medium and an optical beam prior to reflection; and
a second optical detector detecting an intensity of an optical beam reflected from the recording medium.
